(19) United States
(12) Patent Application Publication
(10) Pub. No.: US 2005/0270362 A1
(43) Pub. Date: Dec. 8, 2005

(54) Light source and color thermal printer using the same

(75) Inventor: Hideyuki Kokubo, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/143,566

(22) Filed: Jun. 3, 2005

(30) Foreign Application Priority Data
Jun. 3, 2004 (JP) 2004-166280

(51) Int. Cl. B41J 2/315

(52) U.S. Cl. 347/212

(57) ABSTRACT

A yellow fixing light source of a color thermal printer comprises an aluminum substrate, light emitting elements aligned thereon, and reflectors mounted thereon. The reflector reflects the light emitted from the light emitting element. A part of a power line constituting a wiring pattern is formed on a glass epoxy plate of the reflector. The wiring pattern is prevented from having a dense portion and becomes a simple form. Thus, it is possible to reduce a cost to be taken for forming the wiring pattern. A degree of freedom for raying out the wiring pattern increases and a breadth of the wiring pattern may be widened so that it is possible to prevent luminous unevenness from being caused due to voltage drop to be induced by wiring resistance.

### BACKGROUND OF THE INVENTION

1. Field of the Invention

The present invention relates to a light source including a plurality of light emitting elements, a reflector for reflecting the light radiated from the light emitting element, and a substrate on which the light emitting elements are aligned in rows and the reflector is placed. The substrate is formed with wiring patterns for electrifying the light emitting elements. The present invention is further relates to a color thermal printer using the above-mentioned light source as a light source of a fixing unit.

2. Description of the Related Art

A color thermal printer using a color thermosensitive recording paper is widely used to obtain a full-color print. The color thermosensitive recording paper includes thermosensitive coloring layers, which color in cyan, magenta and yellow, and are formed on a support in order. In such a color thermal printer, thermal recording is performed by a thermal head having aligned heater elements while the color thermosensitive recording paper is fed. After performing the thermal recording for the yellow and magenta thermosensitive coloring layers, a fixing unit applies ultraviolet rays to the color thermosensitive recording paper to perform optical fixation. Thus, the previous thermosensitive coloring layer is not colored when the thermal recording is performed for the following thermosensitive coloring layer.

As to the conventional color thermal printer, an ultraviolet lamp is used as a light source of the fixing unit. However, an ultraviolet-ray application amount of the ultraviolet lamp reduces due to aged deterioration and luminous efficiency thereof becomes worse. Thereupon, lowering a feed speed of the recording paper, for example, is required to obtain the ultraviolet-ray application amount necessary for the optical fixation.

In order to solve the above problem, it is proposed to use a light emitting element of an LED and so forth as the light source of the fixing unit (see Japanese Patent Laid-Open Publication No. 8-180711). If this kind of the light source uses a double-sided substrate on which the light emitting elements are mounted, a problem regarding heat is caused. In consideration of this, a wiring pattern is formed on a mount surface of the light emitting elements. As shown in FIG. 6, a light source 100 is constituted of an aluminum substrate 102 having a wiring pattern 101 formed on an insulating layer, a plurality of light emitting elements 103 aligned on the aluminium substrate 102, and reflectors 104a to 104d placed on the aluminum substrate 102. The reflectors 104a to 104d reflect the light radiated from the light emitting elements 103.

The wiring pattern 101 comprises power lines 101a and 101b for supplying electric power to the respective light emitting elements 103 of first and second element rows L1 and L2. The wiring pattern 101 further comprises signal lines 101c and 101d for individually activating the light emitting elements 103 of the element rows L1 and L2. One end of each of the power lines 101a and 101b is connected to a common terminal 105. One end of each of the signal lines 101c and 101d is connected to an individual terminal 106. Further, a lead wire 107 connected to a power-source circuit (not shown) is soldered on the common terminal 105, and a lead wire 108 connected to a driver IC (not shown) is soldered on the individual terminal 106.

The power lines 101a and 101b are formed between the element rows L1, L2 and the reflectors 104a, 104c respectively. The signal line 101c is formed so as to turn aside from the reflectors 104b and 104c. The signal line 101d is formed between the element row L2 and the reflector 104d, and under a portion where the reflector 104d is placed.

In the light source 100 shown in FIG. 6, layout of the wiring pattern 101 is restricted by the arrangement of the light emitting elements 103 and the reflectors 104a to 104d so that the wiring pattern 101 has a dense portion (especially, a portion of the signal line 101c) and a form of the wiring pattern 101 becomes complicated. Thus, there arises a problem in that cost for forming the wiring pattern 101 increases.

Moreover, since an area for forming the wiring pattern 101 is also restricted, it is impossible to widen a breadth of the wiring pattern 101 so that wiring resistance becomes high to cause voltage drop. Thus, there arises a problem in that deflecting electric power is supplied to the respective light emitting elements 103 to cause luminous unevenness.

### SUMMARY OF THE INVENTION

In view of the foregoing, it is a primary object of the present invention to provide a light source in which cost for forming a wiring pattern is reduced and luminous unevenness of light emitting elements is prevented.

It is a second object of the present invention to provide a color thermal printer in which production cost is reduced and a high-quality print is obtained.

In order to achieve the above and other objects, the light source according to the present invention comprises a plurality of light emitting elements, a first reflector for reflecting the light emitted from the light emitting elements, and a substrate on which the light emitting elements are aligned in rows and the first reflector is mounted. A wiring pattern is formed on the substrate to electrify the light emitting elements. The wiring pattern is partially formed at the first reflector.

In a preferred embodiment, the wiring pattern partially formed at the first reflector is a part of a power line for supplying electric power to the light emitting elements. The wiring pattern of the first reflector may be a part of a signal line for individually activating the light emitting elements or may be a part of a lamp-driver circuit.

Moreover, in the preferred embodiment, the first reflector is disposed in a longitudinal direction of an element row along which the light emitting elements are aligned. The first reflector comprises a reflection member for reflecting the light, and a pattern formation member on which the wiring pattern is partially formed. The light source further comprises a second reflector mounted on the substrate to reflect the light emitted from the light emitting elements. The second reflector comprises the reflection member without the pattern formation member. The first and second reflectors are disposed on the substrate so as to make the reflection members thereof face each other and so as to interpose the element row.

Incidentally, the pattern formation member may be a flexible cable, which is pasted on a non-reflection surface of the first reflector. Meanwhile, the wiring pattern is partially formed at the non-reflection surface of the first reflector or at the interior thereof.

The color thermal printer according to the present invention employs the above-mentioned light source as a light source of a fixing unit for optically fixing a thermosensitive recording paper, for which thermal recording has been performed, by applying fixing light thereto.

According to the light source of the present invention, cost taken for forming the wiring pattern is reduced and luminous unevenness of the light emitting elements is prevented, since the reflector for reflecting the light is formed with a part of the wiring pattern.

According to the color thermal printer of the present invention, cost taken for forming the wiring pattern is reduced and production cost is reduced, since the above-mentioned light source is employed as the light source of the fixing unit. Further, high-quality print may be obtained, since the luminous unevenness of the light emitting elements is prevented.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration showing a structure of a color thermal printer according to the present invention;

FIG. 2 is a perspective view showing a schematic structure of a yellow fixing light source;

FIG. 3 is a plan view showing the schematic structure of the yellow fixing light source;

FIG. 4 is a perspective view showing another embodiment of a reflector;

FIG. 5 is a perspective view showing the other embodiment of the reflector; and

FIG. 6 is a plan view showing a schematic structure of a conventional light source.

### DETAILED DESCRIPTION OF THE PREFERRED EMBODIMENT(S)

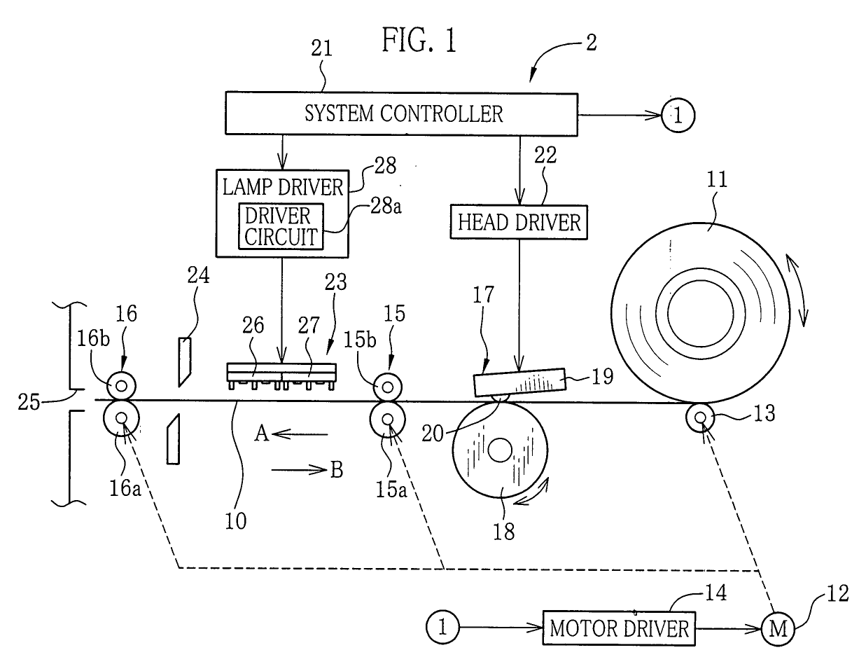

In FIG. 1, a color thermal printer 2 according to the present invention uses a strip of a color thermosensitive recording paper (hereinafter, simply called as recording paper) 10 as a recording material. The recording paper 10 is wound in a roll form and is set in the color thermal printer 2 as a recording-paper roll 11.

As well known, the recording paper 10 includes cyan, magenta and yellow thermosensitive coloring layers and a protective layer, which are formed on a support in order. The yellow thermosensitive coloring layer being as the uppermost layer has the highest heat sensitivity to color in yellow with small thermal energy. The cyan thermosensitive coloring layer being as the lowermost layer has the lowest heat sensitivity to color in cyan with great thermal energy.

The yellow thermosensitive coloring layer loses its coloring ability when near ultraviolet rays of 420 nm to 450 nm have been applied. The magenta thermosensitive coloring layer colors in magenta with intermediate thermal energy, which is ranked between those of the yellow and cyan thermosensitive coloring layers. The magenta thermosensitive coloring layer loses its coloring ability when ultraviolet rays of 365 nm to 390 nm have been applied. Incidentally, the recording paper having four-layer structure may be used. In this case, the recording paper further includes a black thermosensitive coloring layer, for example.

A feed roller 13 abuts on the periphery of the recording-paper roll 11. The feed roller 13 is rotated by a motor 12 which is a stepping motor and is actuated by drive pulses inputted from a motor driver 14. When the feed roller 13 is rotated in a counterclockwise direction in the drawing, the recording-paper roll 11 is rotated in a clockwise direction to advance the recording paper 10 from the recording-paper roll 11. When the feed roller 13 is rotated in the clockwise direction in the drawing, the recording-paper roll 11 is rotated in the counterclockwise direction to rewind the recording paper 10 around the recording-paper roll 11.

The recording paper 10 advanced from the recording-paper roll 11 is sent into a passage, which is horizontally placed and along which a carrying roller pair 15 and a discharge roller pair 16 are disposed to nip and carry the recording paper 10. The carrying roller pair 15 and the discharge roller pair 16 comprises capstan rollers 15a and 16a to be rotated by the motor 12, and pinch rollers 15b and 16b pressed against the capstan rollers 15a and 16a. The roller pairs 15 and 16 reciprocate the recording paper 10 in an A direction (feeding direction) and a B direction (rewinding direction) in the drawing.

A thermal head 17 and a platen roller 18 are disposed between the feed roller 13 and the carrying roller pair 15. The platen roller 18 is disposed at a lower portion of the passage so as to confront the thermal head 17. Regarding a head substrate 19 of the thermal head 17, a surface thereof confronting the recording paper 10 is provided with a heating-element array 20 in which plural heating elements are aligned. The heating-element array 20 heats on the basis of drive data inputted into a head driver 22 from a system controller 21 to color the respective thermosensitive coloring layers of the recording paper 10.

The platen roller 18 is rotated in association with the movement of the recording paper 10 to stabilize the abutment state of the recording paper 10 and the heating-element array 20. In addition, the platen roller 18 is vertically movable and is urged by a spring, which is not shown, in a pressing direction relative to the heating-element array 20. When the recording paper 10 is fed and discharged, the platen roller 18 is lowered by a shifting mechanism (not shown) constituted of a cam, a solenoid and so forth to release the recording paper 10 nipped by the platen roller 18 and the thermal head 17.

At a downstream side of the carrying roller pair 15 in the A direction, a fixing unit 23 is disposed so as to confront a recording surface of the recording paper 10. Moreover, a cutter for cutting the recording paper 10 into a predetermined print size is disposed between the fixing unit 23 and the discharge roller pair 16. Further, a downstream side of the discharge roller pair 16 in the A direction is provided with a discharge port 25 for discharging the recording paper 10, on which an image has been recorded, to the outside.

The fixing unit 23 includes yellow and magenta fixing light sources 26 and 27. The yellow fixing light source 26 fixes the yellow thermosensitive coloring layer by emitting the near ultraviolet rays whose luminous peak is 420 nm to 450 nm. The magenta fixing light source 27 fixes the magenta thermosensitive coloring layer by emitting the ultraviolet rays whose luminous peak is 365 nm to 390 nm. A lamp driver 28 drives the respective light sources 26 and 27 via a driver circuit 28a.

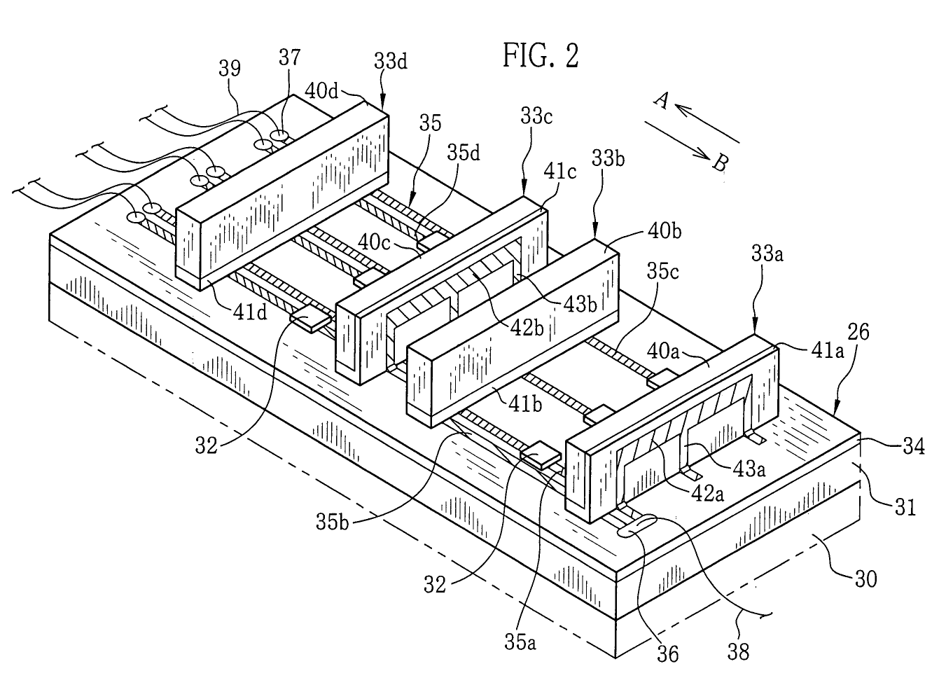

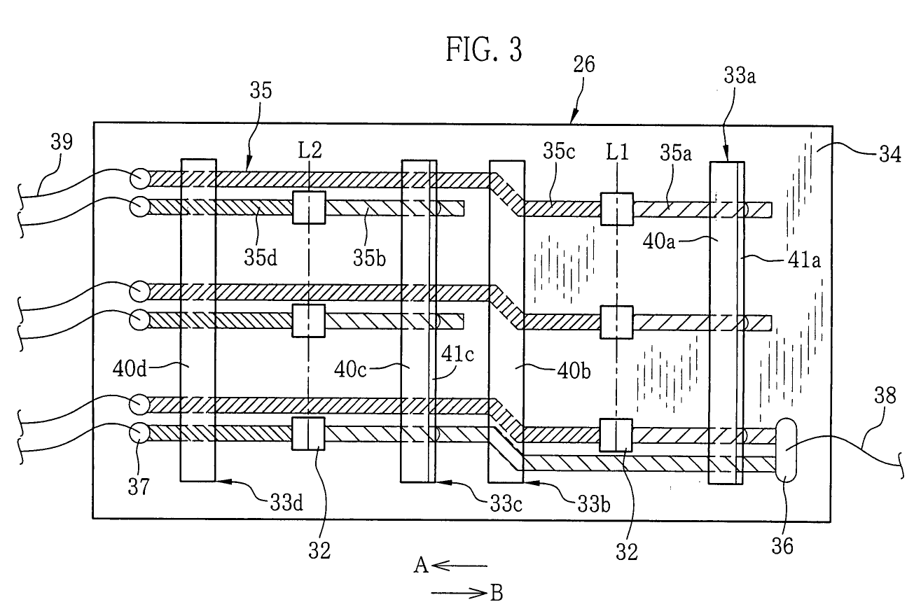

As shown in FIGS. 2 and 3, the yellow fixing light source 26 comprises an aluminum substrate 31 attached to the bottom of a heat sink 30, a plurality of light emitting elements 32 aligned on the aluminum substrate 31, and reflectors 33a to 33d mounted on the aluminum substrate 31. The reflectors 33a to 33d reflect the light emitted from the light emitting elements 32. An insulating layer 34 is provided on the aluminum substrate 31. The insulating layer is formed with a wiring pattern 35 for electrifying the light emitting elements 32.

The wiring pattern 35 comprises power lines 35a and 35b for supplying electric power to the respective light emitting elements 32 of first and second element rows L1 and L2. The wiring pattern 35 further comprises signal lines 35c and 35d for individually driving the respective light emitting elements 32 of the element rows L1 and L2. One end of each of the power lines 35a and 35b is connected to a common terminal 36. One end of each of the signal lines 35c and 35d is connected to an individual terminal 37. Further, a lead wire 38 connected to a power-source circuit (not shown) of the lamp driver 28 is soldered on the common terminal 36, and a lead wire 39 connected to a driver IC (not shown) of the lamp driver 28 is soldered on the individual terminal 37.

The power lines 35a and 35b are formed between the element rows L1, L2 and the reflectors 33a, 33c and are formed under portions where the reflectors 33a, 33b and 33c are mounted. Moreover, the power lines 35a and 35b are slightly extended in the B direction from the portions where the reflectors 33a and 33c are mounted.

The signal line 35c is veeringly formed under the reflector 33b and between the reflectors 33b and 33c so as to turn aside from the extended portion of the power line 35b. Moreover, the signal line 35c is straightly formed toward the individual terminal 37 under the reflectors 33c and 33d, and between the reflectors 33c and 33d. The signal line 35d is straightly formed toward the individual terminal 37 under the reflector 33d and between the element row L2 and the reflector 33d.

The light emitting element 32 comprises an LED for emitting the near ultraviolet rays, of which the luminous peak is 420 nm to 450 nm, to optically fix the yellow thermosensitive coloring layer. In this embodiment, three light emitting elements 32 constitute the respective element rows L1 and L2. However, the number of the light emitting elements 32 constituting the element row is not limited to this embodiment. Moreover, the number of the element rows is not limited to this embodiment. These numbers may be properly changed in accordance with specification of the color thermal printer 2.

The reflectors 33a to 33d are disposed in a longitudinal direction of the element rows L1 and L2 so as to interpose the element rows L1 and L2. The reflectors 33a to 33d include aluminum plates 40a to 40d for reflecting the light emitted from the light emitting elements 32, and glass epoxy plates 41a to 41d. The grass epoxy plates 41a and 41c of the reflectors 33a and 33c have an L-like shape so as to cover lower sides of the aluminum plates 40a and 40c (in FIG. 2), and also cover the upstream sides thereof in the A direction. Meanwhile, the grass epoxy plates 41b and 41d of the reflectors 33b and 33d are provided so as to cover lower sides of the aluminum plates 40b and 40d (in FIG. 2). In virtue of the grass epoxy plates 41a to 41d, the aluminum plates 40a to 40d are insulated from the wiring pattern 35 formed on the portions where the reflectors 33a to 33d are mounted.

The power lines 35a and 35b are partially formed on the glass epoxy plates 41a and 41c of the reflectors 33a and 33c. The portions of the power lines 35a and 35b formed on the glass epoxy plates 41a and 41c comprise main portions 42a and 42b formed in the longitudinal direction of the element rows L1 and L2, and branch portions 43a and 43b diverging from the main portions 42a and 42b to the insulating layer 34. The branch portions 43a and 43b are electrically connected to the extended portions of the power lines 35a and 35b, which are formed on the insulating layer 34, by means of solder. Incidentally, since the magenta fixing light source 27 has the identical structure with the yellow fixing light source 26, description and drawings thereof are abbreviated.

Next, an operation of the color thermal printer 2 having the above structure is described below. Upon performing an operation for commencing image recording, the feed roller 13 is rotated in the counterclockwise direction in association with the forward rotation of the motor 12 to advance the recording paper 10 from the recording-paper roll 11 in the A direction. An anterior end of the recording paper 10 moves in the passage and is nipped by the carrying roller pair 15. Successively, the anterior end of the recording paper 10 is further carried to the downstream side in the A direction.

When the recording paper 10 has reached an image-recording start position, the rotation of the motor 12 is temporarily halted. And then, the platen roller 18 is raised by the shifting mechanism to nip the recording paper 10 with the heating-element array 20. In this state, the motor 12 is driven again. While the recording paper 10 is carried in the A direction, the heating-element array 20 is heated on the basis of the drive data inputted into the head driver 22. By the heated array 20, a yellow image is recorded on the yellow thermosensitive coloring layer of the recording paper 10.

After the yellow image has been recorded, the posterior end of the recorded image is carried until a position confronting the yellow fixing light source 26 of the fixing unit 23, and the rotation of the motor 12 is halted. At this time, the platen roller 18 is lowered by the shifting mechanism to release the recording paper 10 nipped by the platen roller 18 and the thermal head 17. After that, the light emitting elements 32 of the yellow fixing light source 26 are turned on by the lamp driver 28. The yellow thermosensitive coloring layer wherein the image has been recorded is fixed while the recording paper 10 is rewound in the B direction by reversing the motor 12.

After fixing the yellow thermosensitive coloring layer, the anterior end of the recorded image is carried until the position confronting the heating-element array 20, and the rotation of the motor 12 is halted. And then, similarly to the recording of the yellow image, the platen roller 18 is raised by the shifting mechanism to nip the recording paper 10 with the heating-element array 20. In this state, the motor 12 is driven again. While the recording paper 10 is carried in the A direction, a magenta image is recorded on the magenta thermosensitive coloring layer of the recording paper 10.

After the magenta image has been recorded, the posterior end of the recorded image is carried to a position confronting the magenta fixing light source 27 of the fixing unit 23, and the rotation of the motor 12 is halted. And then, similarly to the fixation of the yellow image, the light emitting elements 32 of the magenta fixing light source 27 are turned on by the lamp driver 28. The magenta thermosensitive coloring layer wherein the image has been recorded is fixed while the recording paper 10 is rewound in the B direction by reversing the motor 12.

After fixing the magenta thermosensitive coloring layer, the anterior end of the recorded image is carried to the position confronting the heating-element array 20, and the rotation of the motor 12 is halted. Then, similarly to the recording of the magenta image, a cyan image is recorded on the cyan thermosensitive coloring layer of the recording paper 10.

After recording the image, the recording paper 10 is carried in the A direction by the carrying roller pair 15 and is cut by the cuter 24 into a predetermined print size. Successively, the recording paper 10 is ejected from the discharge port 25 to the outside by the discharge roller pair 16.

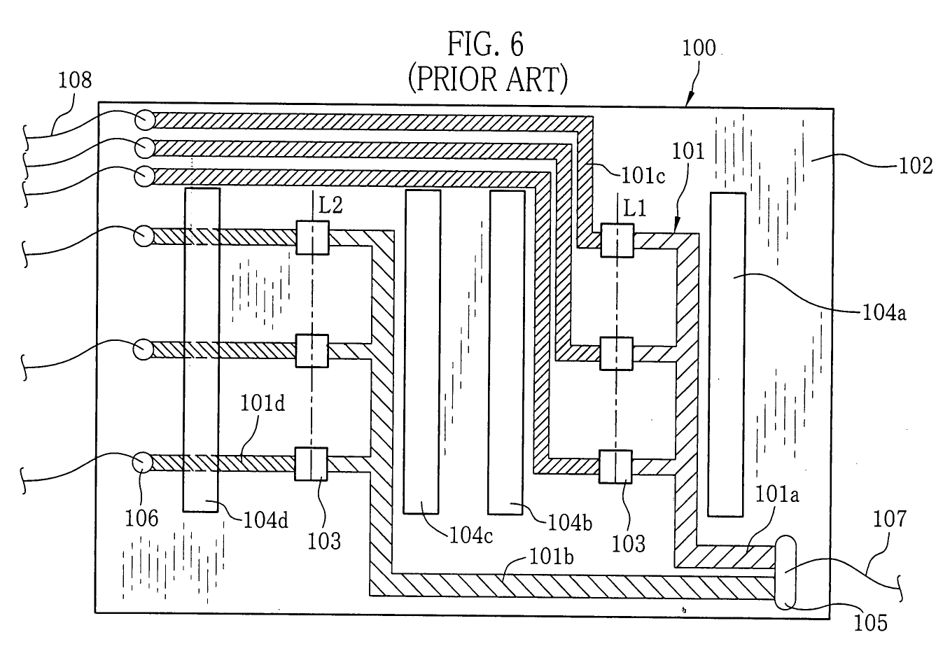

As described above, the power lines 35a and 35b are partially formed on the grass epoxy plates 41a and 41c of the reflectors 33a and 33c. Thus, the wiring pattern 35 is prevented from having a dense region and becomes a simple form in comparison with the conventional light source 100 shown in FIG. 6. It is possible to reduce a cost to be taken for forming the wiring pattern 35. Consequently, it is possible to reduce a production cost of the color thermal printer 2.

In addition, a degree of freedom for laying out the wiring pattern 35 increases and it is possible to widen a breadth of the wiring pattern 35. Thus, luminous unevenness of the light emitting elements 32 may be prevented from being caused due to voltage drop to be induced by the wiring resistance, and it is possible to apply the uniform fixing light to the recording paper 10. As a result, a high-quality print is obtained.

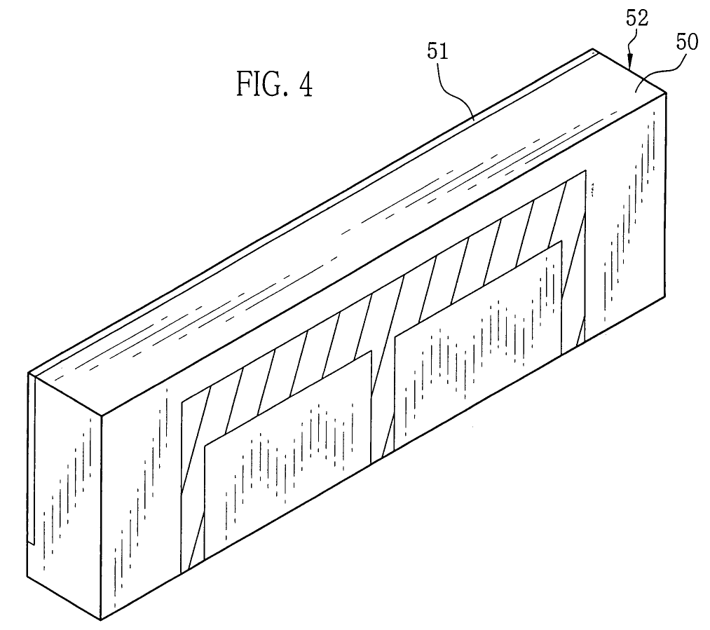

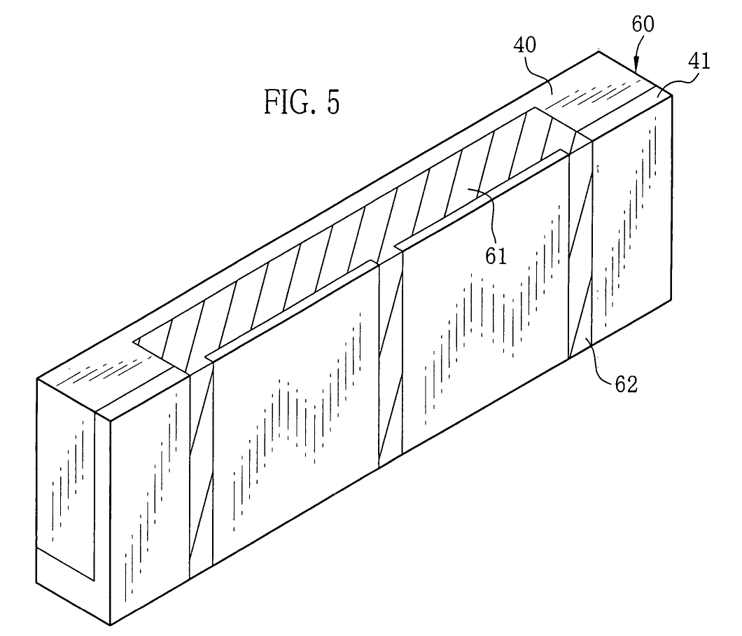

In the above embodiment, the reflectors 33a and 33c are constituted of the glass epoxy plates 41a, 41c and the aluminum plates 40a, 40c having a certain thickness. However, a reflector 52 shown in FIG. 4 may be used. The reflector 52 comprises a grass epoxy plate 50 having a certain thickness, and an aluminum film 51 formed thereon. In this case, it is possible to reduce the production cost by an amount corresponding to material cost of the aluminum plates. Meanwhile, such as shown in FIG. 5, a main portion 61 of the wiring pattern 35 may be formed on a top surface of a reflector 60. Further, instead of the glass epoxy plate, a flexible cable may be used as the pattern formation member. In this case, the flexible cable may be pasted on a non-reflection surface of the aluminum plate. Furthermore, a part of the wiring pattern may be formed at the non-reflection surface of the aluminum plate or at the interior thereof.

In the above embodiment, the power line is described as a part of the wiring pattern formed on the reflector. The present invention, however, is applicable to cases in that a part of the signal line is formed on the reflector and a part of a lamp-driver circuit is formed thereon.

In the above embodiment, the reflectors 33a to 33d are mounted on the aluminum substrate 31 so as to be perpendicular thereto. However, the reflector may be slanted toward the surface on which the light emitting elements 32 are arranged. Further, in the above embodiment, the reflectors 33a to 33d are disposed so as to interpose the element rows L1 and L2 of the light emitting elements 32. However, the reflectors may be disposed so as to surround the element rows L1 and L2.

In the above embodiment, the light source is used for the fixing unit of the color thermal printer 2. The present invention, however, is not limited to this and may be applicable to an image sensor or the like used in a facsimile and a scanner.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A light source comprising:
a plurality of light emitting elements;
a first reflector for reflecting the light emitted from said light emitting elements;
a substrate on which said light emitting elements are aligned in rows, said first reflector being mounted on said substrate; and
a wiring pattern for electrifying said light emitting elements, said wiring pattern being formed on said substrate and being partially formed at said first reflector.

2. A light source according to claim 1, wherein said wiring pattern formed at said first reflector is a part of one of a power line for supplying electric power to said light emitting elements, a signal line for individually activating said light emitting elements, and a driver circuit for driving said light emitting elements.

3. A light source according to claim 1, wherein said first reflector is disposed in a direction of an element row along which said light emitting elements are aligned, and said first reflector comprises a reflection member, which is for reflecting the light, and a pattern formation member on which said wiring pattern is formed.

4. A light source according to claim 3, further comprising:
a second reflector mounted on said substrate to reflect the light emitted from said light emitting elements, said second reflector comprising said reflection member without said pattern formation member.

5. A light source according to claim 4, wherein said first reflector and said second reflector are disposed so as to make said reflection members thereof face each other and so as to interpose said element row.

6. A light source according to claim 3, wherein a thickness of said reflection member is thinner than a thickness of said pattern formation member.

7. A light source according to claim 3, wherein said pattern formation member is a flexible cable, which is pasted on a non-reflection surface of said reflection member.

8. A light source according to claim 3, wherein said reflection member is made of aluminum.

9. A light source according to claim 3, wherein said pattern formation member is a glass epoxy plate.

10. A light source according to claim 3, wherein said wiring pattern formed at said first reflector is electrically connected with said wiring pattern formed on said substrate, by means of a solder.

11. A light source according to claim 1, wherein said wiring pattern of said first reflector is formed at either of a non-reflection surface of said first reflector and the interior thereof.

12. A color thermal printer having a fixing unit for performing optical fixation by applying fixing light to a thermosensitive recording paper for which thermal recording has been performed, a light source of said fixing unit comprising:
a plurality of light emitting elements;
a reflector for reflecting the light emitted from said light emitting elements;
a substrate on which said light emitting elements are aligned in rows, said reflector being mounted on said substrate; and
a wiring pattern for electrifying said light emitting elements, said wiring pattern being formed on said substrate and being partially formed at said first reflector.
